(19) United States
(12) Patent Application Publication
(10) Pub. No.: US 2017/0210098 A1
(43) Pub. Date: Jul. 27, 2017

(54) PERMEABLE ELASTOMERIC MEMBRANE ADHERED TO FIRE-RATED STRUCTURAL OSB PANELS

(71) Applicants: HEIDI MOORE, MT. JULIET, TN (US); BRIAN ST. GERMAIN, MT. JULIET, TN (US)

(72) Inventors: HEIDI MOORE, MT. JULIET, TN (US); BRIAN ST. GERMAIN, MT. JULIET, TN (US)

(21) Appl. No.: 15/365,731

(22) Filed: Nov. 30, 2016

Related U.S. Application Data
(60) Provisional application No. 62/260,663, filed on Nov. 30, 2015.

(51) Int. Cl. B32B 23/04; E04B 1/66; E04B 1/94

(52) U.S. Cl. CPC B32B 23/044; E04B 1/948; E04B 1/665

(57) ABSTRACT

A multi-layer panel for use as structural sheathing. A first or base layer is a wood structural panel, such as OSB or plywood, which coated or treated with a product that provides fire resistance. The fire resistant treatment may be integrated with the material forming the wood structural panel, or may be one or more FR coating layers, one or more sides of the wood structural panel. A third layer is a weather or water resistive barrier (WRB), which may be applied as a coating on one or more sides in the manufacturing line. The multi-layer panel product provides fire-rated structural sheathing with WRB in a single product, which is less reliant on skilled labor for installation at a job site and reduces installation time.

This application claims benefit of and priority to U.S. Provisional Application No. 62/260,663, filed Nov. 30, 2015, by Heidi Moore, et al., and is entitled to that filing date for priority. The specification, figures, appendices and complete disclosure of U.S. Provisional Application No. 62/260,663 are incorporated herein in their entireties by specific reference for all purposes.

### FIELD OF INVENTION

This invention relates to a multi-layered structural panel (which can be wood-based, such as OSB, oriented strand board, plywood, or other cellulistic panel) used for structural sheathing that is both fire resistant and weather/water resistant.

### BACKGROUND OF THE INVENTION

Building wall and roof assemblies are typically layers of several materials, each performing a single function, that are installed separately on the site in which the building is being constructed. Compatibility between the various layers creates challenges not only for the designer, but also for the installers.

A typical layer in most such assembles in a wood panel product, or an integral composite engineered panel product, including, but not limited to, engineered wood composite products formed of lignocellulosic strands or wafers (sometimes referred to as oriented-strand board, or OSB). Products such as fiberboard and particleboard have been found to be acceptable alternatives in most cases to natural wood paneling, sheathing and decking lumber. Fiberboard and particleboard are produced from wood particles bonded together by an adhesive, the adhesive being selected according to the intended use of and the properties desired for the lumber. Often times, the adhesive is combined with other additives to impart additional properties to the lumber. Additives can include fire retardants, insect repellants, moisture resistants, fungus resistants, and color dyes. A significant advantage of fiberboard and particleboard lumber products is that they have many of the properties of plywood, but can be made from lower grade wood species and waste from other wood product production, and can be formed into lumber in lengths and widths independent of size of the harvested timber.

A major reason for increased presence in the marketplace of the above-described product alternatives to natural solid wood lumber is that these materials exhibit properties like those of the equivalent natural solid wood lumber, especially, the properties of retaining strength, durability, stability and finish under exposure to expected environmental and use conditions. A class of alternative products are multilayer oriented wood strand particleboards, particularly those with a layer-to-layer oriented strand pattern, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. No. 3,164,511, U.S. Pat. No. 4,364,984, U.S. Pat. No. 5,435,976, U.S. Pat. No. 5,470,631, U.S. Pat. No. 5,525,394, U.S. Pat. No. 5,718,786, and U.S. Pat. No. 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above described type are produced with bending, tensile strengths and face strengths comparable to those of commercial softwood plywood.

Building wall and roof assemblies typically are constructed by attaching several panels of the above described type as to an underlying supporting structure frame as “sheathing.” These sheathing panels are often placed in a pattern with the edge of each panel contacting adjacent panels, thereby forming a substantially continuous flat surface. In certain types of construction, the panels (and other construction materials) may be required under applicable building to meet certain fire resistance or water resistance requirements.

In prior art applications, a fire resistant panel is installed as sheathing at a job or construction site. After installation, a code-approved water resistant barrier (WRB) system or material is applied. Examples of these WRB systems include housewrap (e.g. Tyvek, Typar), peel-and-stick membranes, or a WRB fluid or liquid applied to the installed panel. However, these systems all rely upon skilled labor for installation at the job. In addition, many of the systems cannot be installed during inclement weather, and require the installed sheathing to be free of defects and provide a clean surface free of debris in order to achieve proper adhesion between the panel and the WRB. As a result, all of these system can be problematic to install on a job site, and often result in improper installation causing failures in the building “envelope,” leading to problems such as moisture instruction or mold or mildew growth. Examples of installation failures include, but are not limited to, reverse lapping, inconsistent thickness of the applied WRB, and improper adhesion of the WRB to the panel. These prior art systems also increase safety risks at the job site, since the installer must handle bulky or clumsy materials at potentially high elevations for long periods of time.

Accordingly, what is needed is a wood or wood composite product panel that provides fire resistance and water resistance without the need for a WRB system applied at the job or construction site.

### SUMMARY OF INVENTION

In various exemplary embodiments, the present invention comprises a multi-layer panel for use as structural sheathing. The multi-layer panel comprises a wood structural panel, such as OSB or plywood, coated or treated with a product that provides fire resistance. The treatment may be integrated with the material forming the wood structural panel, or may be a coating layer. In several embodiments, the treatment gives it a Fire Resistant (FR) rating (for use in one or two hour rated assemblies, measured from the inside or the outside). The panel also is coated with a weather or water resistive barrier (WRB) of some kind. The invention thus combines a fire-rated structural sheathing and WRB in one multi-layer panel product, which is less reliant on skilled labor for installation at a job site and reduces installation time by eliminating the application of a WRB system in the installation process.

The multi-layer panel provides a fire-code-approved product that provides structural performance and fire resistance in walls and roofs in applications that require a fire rating, such as residential, single- or multi-family, and commercial construction. In one embodiment, the panel comprises an OSB sheathing panel with a FR treatment applied to one or both sides of the panel. The FR treatment may comprise one or more of the following: pyrotite coating; non-combustible magnesium oxide coating; non-combustible fiberglass reinforced magnesium oxide coating; fire-resistant/resistance wood structural panel; flame-block barrier; intumescent coating; integral or surface applied chemical treatment; or combinations thereof. This FR treatment allows the panel to be used in approved one and two hour fire-rated assemblies. As an alternative to FR-treated OSB sheathing panels, sheathing panels also may comprise glass mat sheathing or FRT plywood.

In contrast to the prior art, where a WRB system is separately applied to sheathing panels at the job site after installation, the present invention applies a WRB to the FR panel at the manufacturing facility, prior to shipping or installation at a job site, thereby avoiding the problems noted above with regard to prior art systems.

In one embodiment, a fluid or liquid applied membrane is applied as the WRB via one or more spray nozzles in a manufactured line process. The spray nozzle or nozzles are in fluid communication with one or more storage tanks, and the liquid may be stored without the use of agitators. As the panel travels down a secondary production line, the WRB coating is sprayed on the top face of the panel. In some embodiments, the WRB coating also may be applied to the edges of the panel. If the coating is not sprayed on the edges, the edges may sealed by other means. In embodiments where the FR treatment is an applied FR coating, the WRB coating may be applied over the FR coating. In some embodiments, the WRB coating is applied to a single face of the panel (i.e., the top face), while in other embodiments, the WRB coating is applied to both faces of the panel.

As a result of this in-line process, the WRB coating is applied at a consistent thickness across the panel without any thin or uncovered areas. In one exemplary embodiment, the WRB coating is applied at a thickness of from approximately 5 mills to 10 mils. In another exemplary embodiment, the WRB coating is applied at a minimum thickness of approximately 7 mils.

After drying, branding or markings, if any, to be applied to the panel are then applied or printed on the coated surface of the desired face, such as by using a digital printer or other stamping process. This marking also may be performed in the manufacturing line.

### BRIEF DESCRIPTION OF THE DRAWINGS

FIG. 1 shows a view of a sheathing panel installed between framing studs and exterior cladding in accordance with an embodiment of the present invention.

FIG. 2 shows a cross-section of a sheathing panel with a FR coating layer and WRB coating layer.

FIG. 3 shows a cross-section of a sheathing panel with double-sided FR coating layers and an WRB coating layer.

FIG. 4 shows a cross-section of a sheathing panel with integral FR and an WRB coating layer.

FIG. 5 shows a cross-section of a sheathing panel with integral FR and double-sided WRB coating layers.

FIG. 6 shows a cross-section of a sheathing panel with integral FR and double-sided WRB coating layers, with WRB edge coating.

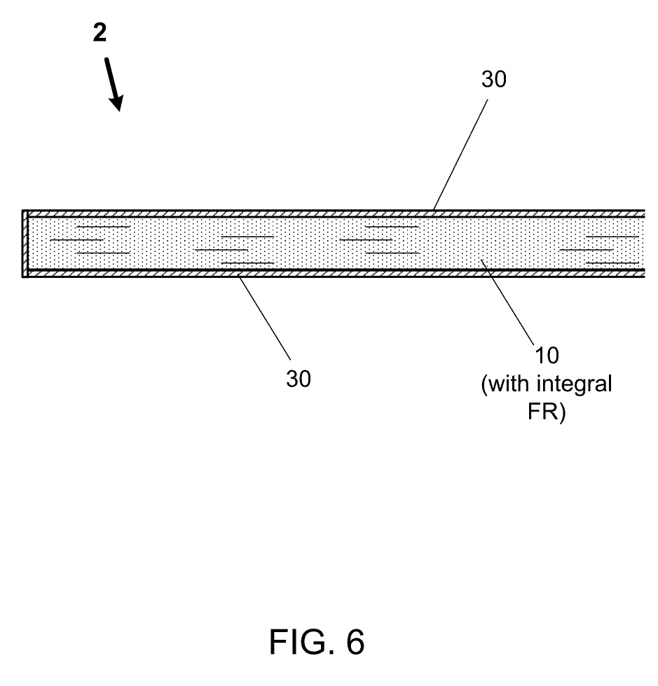

FIG. 7 shows an exploded view of an embodiment of the sheathing panel (with double-side FR coating layers) in a wall assembly with exterior cladding, insulation, studs and gypsum boards.

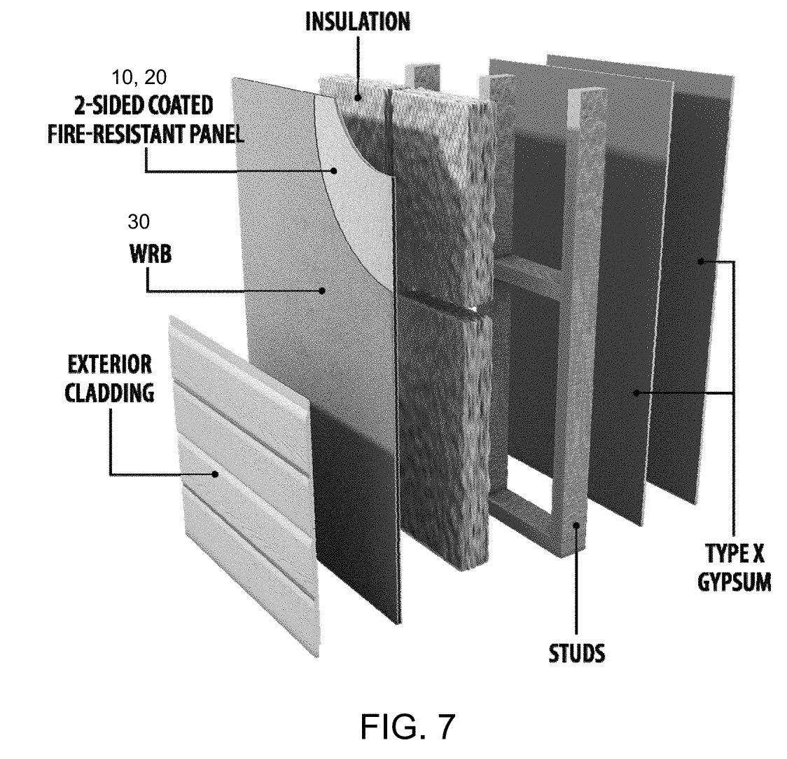

FIG. 8 shows an exploded view of an embodiment of the sheathing panel (with integral FR) in a wall assembly with exterior cladding, insulation, studs and gypsum boards.

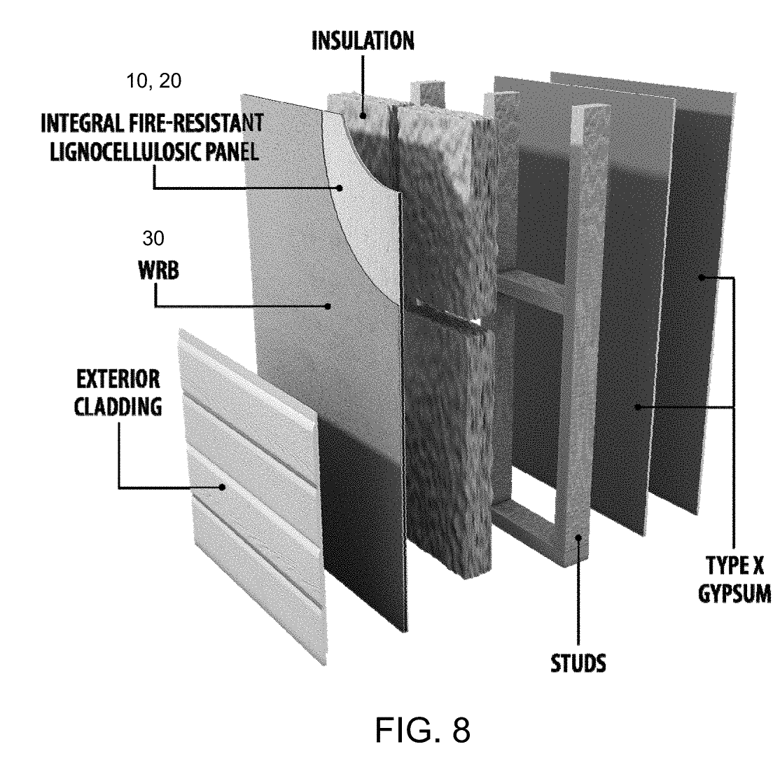

FIG. 9 shows an exemplary process for manufacturing an OSB panel with integral FR and an WRB layer.

FIG. 10 shows an exemplary process for manufacturing an OSB panel with an FR coating layer and an WRB layer.

### DETAILED DESCRIPTION OF EXEMPLARY EMBODIMENTS

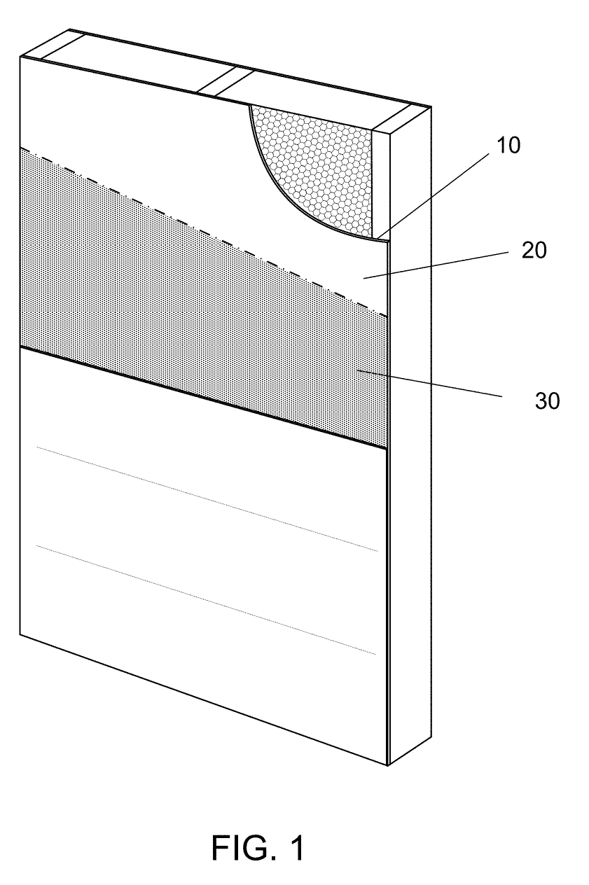

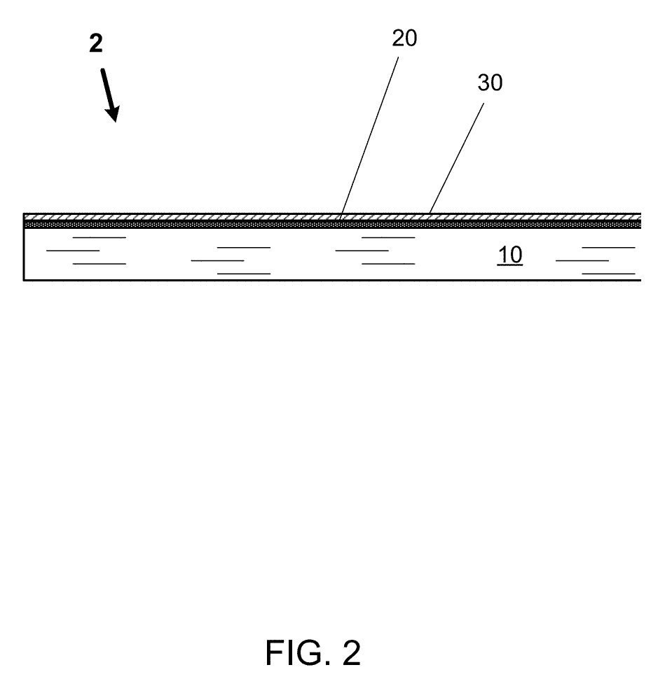

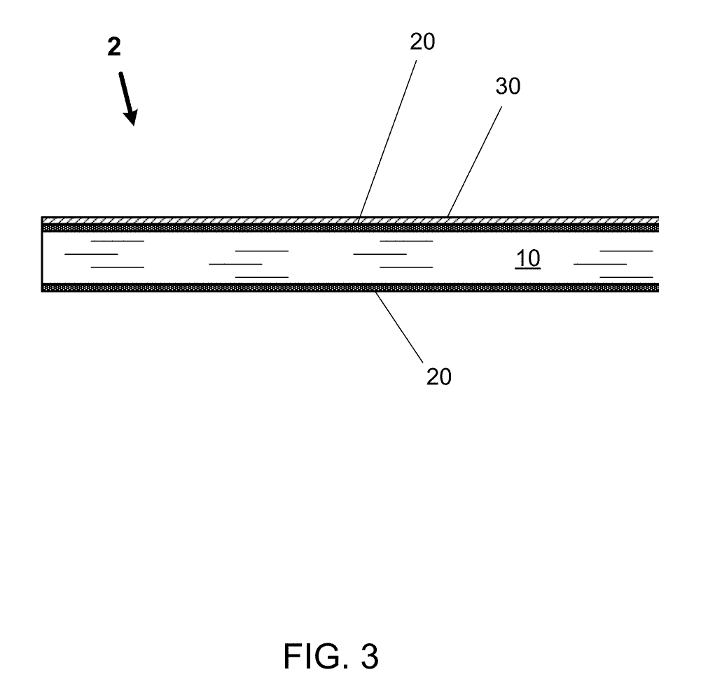

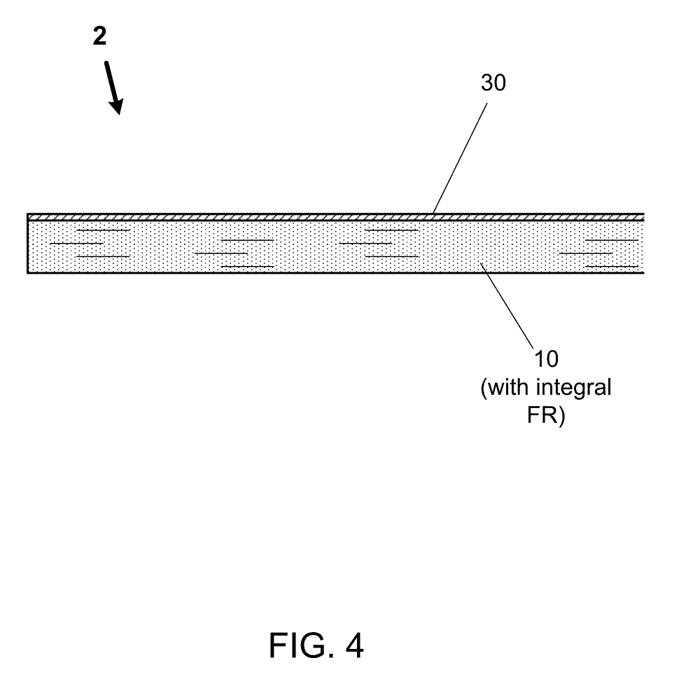

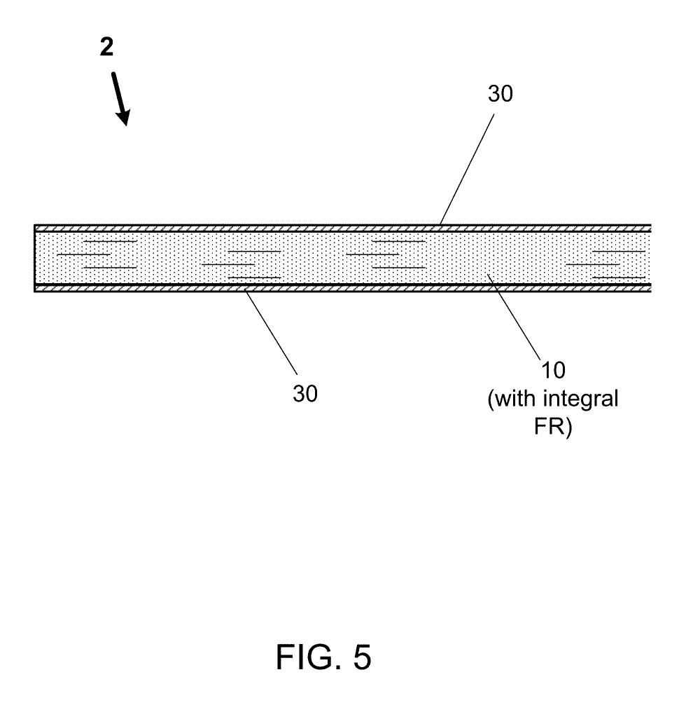

In various exemplary embodiments, as seen in FIGS. 1-5, the present invention comprises a multi-layer panel 2 for use as structural sheathing. The multi-layer panel comprises a wood structural panel 10, such as OSB or plywood, coated or treated with a product that provides fire resistance. The treatment may be integrated with the material forming the wood structural panel, or may be a coating layer 20. In several embodiments, the treatment gives it a Fire Resistant (FR) rating (for use in a one or two hour rated assemblies). The panel also is coated with a weather or water resistive barrier (WRB) 30 of some kind. The invention thus combines a fire-rated structural sheathing and WRB in one multi-layer panel product, which is less reliant on skilled labor for installation at a job site and reduces installation time by eliminating the application of a WRB system in the installation process.

The multi-layer panel provides a fire-code-approved product that provides structural performance and fire resistance in walls and roofs in applications that require a fire rating, such as residential, single- or multi-family, and commercial construction. In one embodiment, the panel comprises an OSB sheathing panel 10 with a FR treatment 20 applied to one or both sides of the panel. The FR treatment may comprise one or more of the following: pyrotite coating; non-combustible magnesium oxide coating; non-combustible fiberglass reinforced magnesium oxide coating; fire-resistant/resistance wood structural panel; flame-block barrier; intumescent coating; integral or surface applied chemical treatment; or combinations thereof. This FR treatment allows the panel to be used in approved one and one hour fire-rated assemblies. As an alternative to FR-treated OSB sheathing panels, sheathing panels 10 also may comprise glass mat sheathing or FRT (fire rated treated) plywood, for example.

In contrast to the prior art, where a WRB system is separately applied to sheathing panels at the job site after installation, the present invention applies a WRB coating 30 to the FR panel at the manufacturing facility, prior to shipping or installation at a job site, thereby avoiding the problems noted above with regard to prior art systems.

In one embodiment, a fluid or liquid applied membrane is applied as the WRB 30 via one or more spray nozzles in a manufactured line process. The spray nozzle or nozzles are in fluid communication with one or more storage tanks, and the liquid may be stored without the use of agitators. As the panel travels down a secondary production line, the WRB coating is sprayed on the top face of the panel. In some embodiments, the WRB coating also may be applied to the edges of the panel. If the coating is not sprayed on the edges, the edges may sealed by other means. In embodiments where the FR treatment is an applied FR coating 20, the WRB coating 30 may be applied over the FR coating. In some embodiments, the WRB coating is applied to a single face of the panel (i.e., the top face), while in other embodiments, the WRB coating is applied to both faces of the panel.

As a result of this in-line process, the WRB coating is applied at a consistent thickness across the panel without any thin or uncovered areas. In one exemplary embodiment, the WRB coating is applied at a thickness of from approximately 5 mils to approximately 10 mils. In another exemplary embodiment, the WRB coating is applied at a minimum thickness of approximately 5 to 7 mils.

In various exemplary embodiments, the fluid or liquid applied membrane comprises a polyurea coating, polyurea prepolymers, polyurethane coating, solvent-based coating, water-based acrylic coating, elastomeric asphalt emulsions, or combinations thereof. Examples of commercially-available materials or products include, but are not limited to, the above materials marketed under the trade names RUBINATE, SUPRASEC and JEFFOL (by Huntsman Corporation), POLYQUIK (by Williamette Valley Company), or AIR BLOC (by Henry Company).

The applied WRB is substantially bulk water resistant while water vapor permeable, with ratings dependent upon the type of WRB fluid or liquid, and the coating thickness. In several embodiments, the FR/WRB panels of the present invention may be characterized by a liquid water transmission rate from approximately 1 to approximately 30 gms/100 cubic inches/24 hours via Cobb ring test (based on the ASTM D5795 procedure), a water vapor permeance from approximately 0.1 perms to about 1.0 perms (U.S.), a water vapor permeance from about 0.1 to about 15 perms (U.S.) (based on

ASTM E96 Procedure B) and a water vapor transmission rate of from 0.5 to about 10 gms/square meters/24 hours (based on ASTM E96 Procedure A).

After drying, branding or markings, if any, to be applied to the panel are then applied or printed on the coated surface of the desired face, such as by using a digital printer or other stamping process. This marking also may be performed in the manufacturing line.

During installation at a job or construction site, the sheathing panels often are gapped installation according to appropriate guidelines for the structural sheathing (e.g., ⅛″ gapping). The gaps between the panels are then sealed on-site after installation using a WRB sealant means, such as, but not limited to, (1) a fluid applied spray WRB sealant of similar chemical makeup to the coating applied to the face of the panel, (2) tape that bridges the gap (e.g., approximately 3″ in width), or (3) self-troweling sealant applied using an electric caulk gun. These sealant means may be water vapor permeable. When installed, the system provides the structure with an integral, monolithic building envelope that functions as an effective water resistive barrier (i.e., resists bulk water) and an effective air barrier system that is vapor permeable. fire-rated and structural.

The present invention possess several advantages over the prior art. It provides a savings in time and labor, as a secondary contractor is not needed to apply the WRB system after a FR sheathing panel is installed. Further, coating the panels in a controlled setting (e.g., manufacturing facility) allows the thickness of the coating to be consistently applied, and further allows the coating the opportunity to fully bond with the panel. More specifically, the coating can fully cure independent of weather conditions, and be applied to a clean panel without interference from construction-related dirt, debris or humidity. Further, since the WRB is preapplied to the panel, it reduces the number of penetrations in the wall assembly installation process, and thereby reduces air infiltration into the wall cavity. The present invention also prevents air movement between the WRB layer and the face of the underlying panel. These enhancements increase system performance, installation reliability and structure durability while decreasing construction related waste.

In addition, the elastomeric properties of the WRB coating allows it to “wrap-around” nails that penetrate the panel. This provides a sealing effect, and is in sharp contrast to prior art housewrap systems, where chipping or tearing often occurs at the point of penetration (thereby compromising the overall integrity of the system). The present system also reduces the amount and number of materials needed to be delivered and stored at a job site.

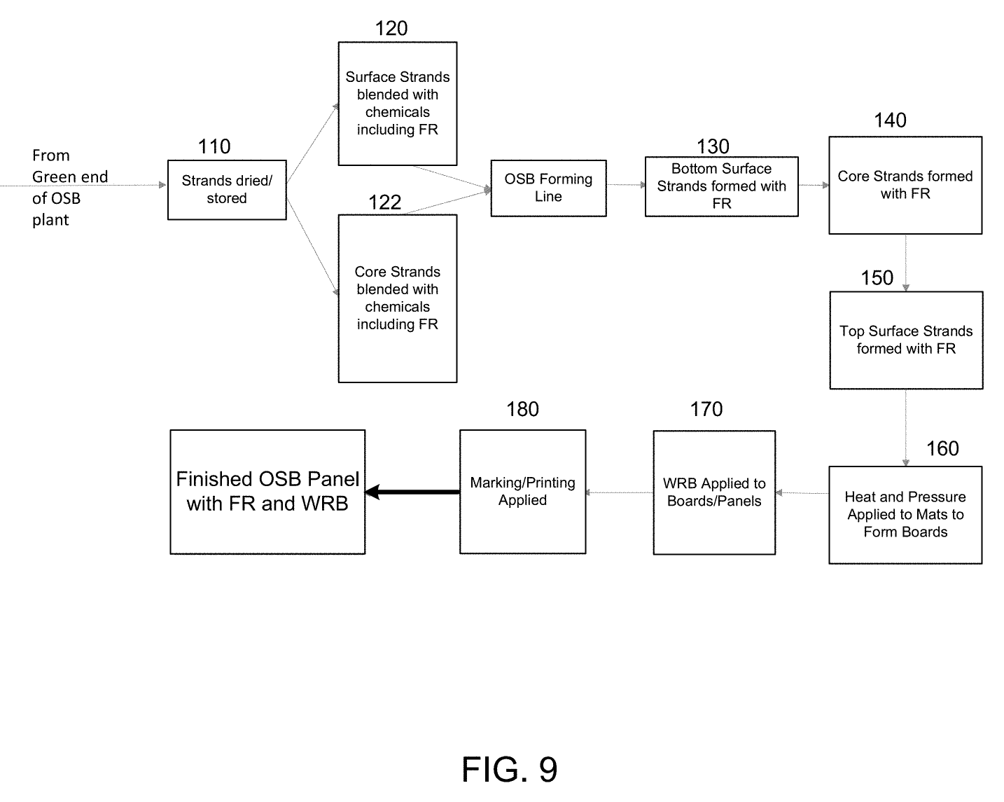

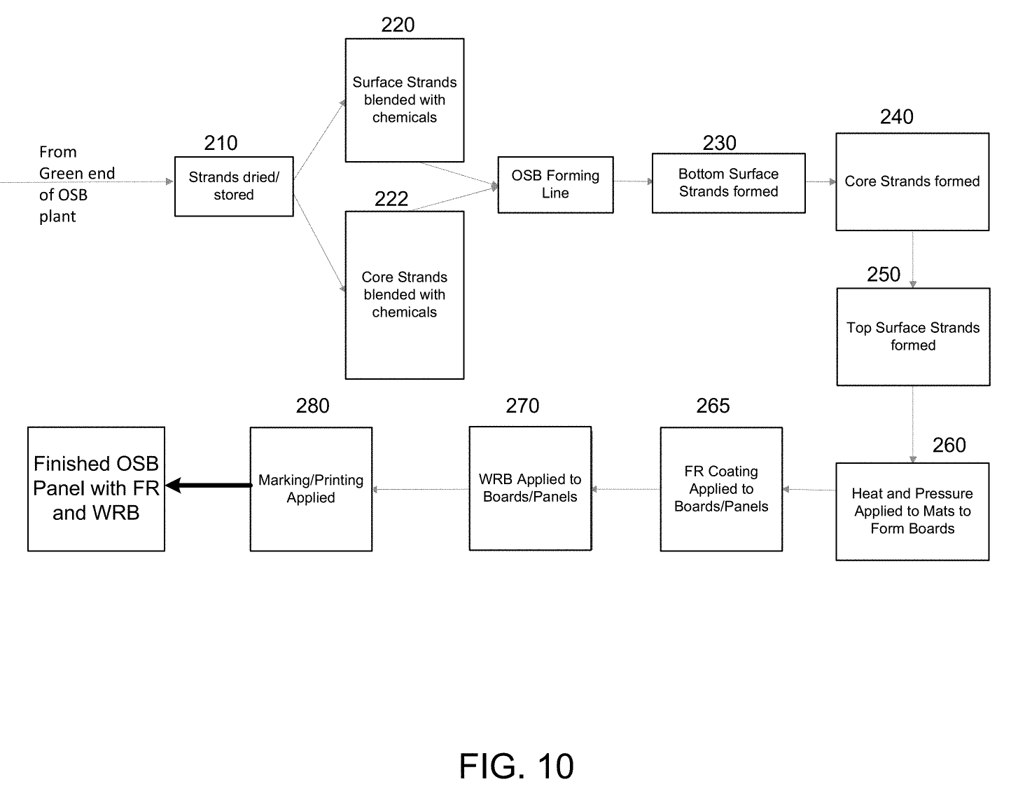

General elements of the OSB manufacturing process, as seen in FIGS. 9 and 10, include the drying and storing of woods strands 110, 210, the treatment or blending of designated strands (e.g., bottom, core, top) with applicable chemicals or additives (e.g., wax, resin, and the like) 120, 122, 220, 222, the forming of the appropriate layers in order (first bottom surface, then core, then top surface) using designated strands, 130, 140, 150, 20, 240, 250, and the application of heat and pressure to the mats using one or more production presses to form boards 160, 170, with subsequent processing (e.g., panels cut to size, edges sealed, and packaging) to produce the finished product.

FIG. 9 shows an embodiment of the manufacturing process where the core strands (and, optionally, the surface strands) are coated or mixed with the FR material in a strand blender or blenders 120, 122. The FR material can be blended with the core strands separately, or along with other additives typically added during the OSB process, such as wax or resin. Treated core strands are used to form the central layer 140, sandwiched between the bottom surface and top surface. WRB layer or layers are then applied 170, followed by any marking or printing as described above 180. The finished product is an OSB panel with integral FR and one or more WRB layers.

FIG. 10 shows another embodiment of the manufacturing process where the FR material or materials are applied through a spraying or flow coating process 265 in the forming line. This coating process may comprise applying the FR coating to the panel, initiating the coating cure in an oven, and completing coating curing in a chamber. WRB layer or layers are then applied 270, followed by any marking or printing as described above 280. The finished product is an OSB panel with one or more FR coating layers and one or more WRB layers.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A fire-resistant structural panel, comprising:
a base layer with a first surface and a second surface;
at least one fire resistant layer substantially coating the first surface or second surface, or both; and
at least one water resistant layer substantially coating the at least one fire resistant layer opposite the base layer.

2. The panel of claim 1, wherein the base layer comprises wood or engineered composite material.

3. The panel of claim 1, wherein the base layer comprises OSG, fiberboard, particleboard, or plywood.

4. The panel of claim 1, wherein the at least one fire resistant layer comprises pyrotite, non-combustible magnesium oxide, non-combustible fiberglass reinforced magnesium oxide, a flame block barrier, or combinations thereof.

5. The panel of claim 1, wherein the at least one water resistant layer comprises a fluid or liquid-applied membrane of consistent thickness.

6. A fire-resistant structural panel, comprising:
a base layer with a first surface and a second surface, wherein the base layer comprises integral fire resistant material; and
at least one water resistant layer substantially coating the first surface or second surface, or both.

7. The panel of claim 6, wherein the base layer comprises wood or engineered composite material treated or coated with fire resistant material or additives.

8. The panel of claim 6, wherein the base layer comprises OSG, fiberboard, particleboard, or plywood treated or coated with fire resistant material or additives.

9. The panel of claim 1, wherein the at least one water resistant layer comprises a fluid or liquid-applied membrane of consistent thickness.

10. A method of producing water-resistant and fire-resistant structural panel, comprising the steps of:
producing wood strands;
treating some or all of the wood strands with chemicals or additives, or both;
forming, in a production line, a mat with one or more layers from said treated wood strands;
applying, in said production line using a production press, heat and pressure to the mat to form a board with a first surface and a second surface;
applying, in said production line, a water resistant barrier to the first surface or second surface, or both; and
cutting the board to produce a finished structural panel.

11. The method of claim 10, further comprising the step of, after applying the water resistant barrier, marking the first surface or second surface.

12. The method of claim 10, wherein the step of treating some or all of the wood strands comprises blending some or all of the woods strands with a fire resistant treatment material.

13. The method of claim 10, further comprising the step of applying a fire resistant coating to the first surface or second surface, or both.

14. The method of claim 13, wherein the step of applying a water resistant barrier is performed after the step of applying a fire resistant coating.

15. The method of claim 10, wherein the step of applying a water resistant barrier comprises spraying, using one or more spray nozzles, a fluid or liquid membrane on the first surface or second surface, or both.

16. The method of claim 15, wherein the fluid or liquid membrane is sprayed on in an consistent thickness.

17. The method of claim 16, wherein the fluid or liquid membrane has a minimum thickness of approximately 5 mils.

18. The method of claim 16, wherein the fluid or liquid membrane has a thickness of approximately 5 mils to approximately 10 mils.
